(19) United States
(12) Patent Application Publication
(10) Pub. No.: US 2019/0344238 A1
(43) Pub. Date: Nov. 14, 2019

(54) MICROCAPSULE AND METHOD FOR PRODUCING THE SAME

(71) Applicant: FUJIFILM CORPORATION, Tokyo (JP)

(72) Inventors: Yu ISOBE, Shizuoka (JP); Hirotaka KITAGAWA, Shizuoka (JP)

(21) Appl. No.: 16/519,021

(22) Filed: Jul. 23, 2019

Related U.S. Application Data
(63) Continuation of application No. PCT/JP2018/011648, filed on Mar. 23, 2018.

(30) Foreign Application Priority Data
Mar. 28, 2017 (JP) 2017-063993

(51) Int. Cl. B01J 13/16; C11B 9/00

(52) U.S. Cl. CPC B01J 13/16; C11B 9/0034

(57) ABSTRACT

Provided are a microcapsule encapsulating a solvent, the solvent having a solubility parameter of greater than or equal to 8 (cal/cm³)^{1/2} and less than 10 (cal/cm³)^{1/2} and a molecular weight of from 425 to 3,000; and a method for producing the microcapsule.

### CROSS-REFERENCE TO RELATED APPLICATIONS

This application is a continuation application of International Application No. PCT/JP2018/011648, filed Mar. 23, 2018, the disclosure of which is incorporated herein by reference in its entirety. Further, this application claims priority from Japanese Patent Application No. JP 2017-063993, filed Mar. 28, 2017, the disclosure of which is incorporated herein by reference in its entirety.

### BACKGROUND OF THE INVENTION

### 1. Field of the Invention

The present disclosure relates to microcapsules and a method for producing the same.

### 2. Description of the Related Art

In recent years, microcapsules have attracted attention from the viewpoint that microcapsules can provide new values in terms of encapsulating and protecting functional materials such as a fragrance, a dye, a heat storage material, and a pharmaceutical component, and in terms of releasing the functional materials in response to stimulation.

It is general to produce microcapsules by adding a functional material, a solvent that dissolves the functional material, and an oil phase containing a shell material into an aqueous phase containing an emulsifier, emulsifying the mixture, subsequently forming a shell by an interfacial polymerization method or the like, and encapsulating the functional material and the solvent in the shell.

Regarding a method for producing such microcapsules, for example, JP2007-187691A discloses “a method for producing microparticle-encapsulating hollow microcapsules, the method including subjecting a polymerizable monomer to a radical polymerization reaction at the interface between an oil-soluble solvent having microparticles dispersed therein and a water-soluble solvent, forming capsule walls to thereby form microparticle-encapsulating microcapsules, subsequently removing the oil-soluble solvent by a reduced pressure process of reducing pressure to 100 Pa or less, wherein the oil-soluble solvent has a solubility parameter of 7 to 10 [cal/cm³]^{1/2}”.

For example, JP2003-525257A discloses nanocapsules having an average particle size of less than 150 nm.

### SUMMARY OF THE INVENTION

For microcapsules, as the particle size distribution is more monodispersed (that is, the particle size distribution is narrower), it is more preferable because control of the functions to be exhibited is easy; however, in order to increase the monodispersity, there is a problem that special emulsification facilities are required.

In the method for producing microcapsules described in JP2007-187691A, since the molecular weight of the oil-soluble solvent is small, the solvent is easily volatilized in a production process including an emulsification step and a polymerization step. Therefore, the amount of the core substance encapsulated in the microcapsules differs for each capsule, and microcapsules having high monodispersity are not obtained.

Furthermore, in regard to the production of microcapsules, in a case in which the solubility parameter (hereinafter, also referred to as “SP value”) of the solvent is large (that is, being highly hydrophilic), the oil phase and the aqueous phase are easily mixed, and the monodispersity of microcapsules thus produced is lowered (that is, the particle size distribution becomes wide).

On the other hand, in regard to the production of microcapsules, in a case in which the SP value of the solvent is small (that is, being highly hydrophobic), since an emulsion formed of an oil phase and an aqueous phase becomes unstable in water, coalescence of emulsions is likely to occur, and microcapsules having high monodispersity are not obtained.

Therefore, an object of one embodiment of the invention is to provide microcapsules having high monodispersity. Another object of one embodiment of the invention is to provide a method for producing microcapsules having high monodispersity without using special emulsification facilities.

Specific means for achieving the objects described above include the following aspects.

<1> A microcapsule encapsulating a solvent, the solvent having a solubility parameter of greater than or equal to 8 (cal/cm³)^{1/2} and less than 10 (cal/cm³)^{1/2} and a molecular weight of from 425 to 3,000.

<2> The microcapsules according to <1>, wherein the solvent is an ester obtained by condensation of a polyol and a fatty acid.

<3> The microcapsule according to <2>, wherein the polyol has three or more hydroxyl groups per molecule.

<4> The microcapsule according to <3>, wherein the polyol is a polyglycerin.

<5> The microcapsule according to any one of <2> to <4>, wherein the fatty acid is a fatty acid having 2 to 30 carbon atoms.

<6> The microcapsule according to any one of <1> to <5>, wherein the microcapsule has a volume-standard median diameter of 1 μm to 50 μm.

<7> The microcapsule according to any one of <1> to <6>, wherein the microcapsule has a coefficient of variation of the particle size distribution of 40% or less.

<8> A method for producing microcapsule, the method comprising:

a step of dispersing an oil phase including a solvent having a solubility parameter of greater than or equal to 8 (cal/cm³)^{1/2} and less than 10 (cal/cm³)^{1/2} and a molecular weight of from 425 to 3,000 and a shell material in an aqueous phase including an emulsifier to prepare an emulsion; and

a step of polymerizing the shell material at an interface between the oil phase and the aqueous phase to form a shell, and forming a microcapsule encapsulating the solvent.

<9> The method for producing microcapsule according to <8>, wherein the solvent is an ester obtained by condensation of a polyol and a fatty acid.

<10> The method for producing microcapsule according to <9>, wherein the polyol has three or more hydroxyl groups per molecule.

<11> The method for producing microcapsule according to <10>, wherein the polyol is polyglycerin.

<12> The method for producing microcapsule according to any one of <9> to <11>, wherein the fatty acid is a fatty acid having 2 to 30 carbon atoms.

<13> The method for producing microcapsule according to any one of <8> to <12>, wherein the microcapsule has a volume-standard median diameter of 1 μm to 50 μm.

<14> The method for producing microcapsule according to any one of <8> to <13>, wherein a concentration of the emulsifier is more than 0% by mass and less than or equal to 20% by mass with respect to a total mass of the emulsion.

<15> The method for producing microcapsule according to any one of <8> to <14>, wherein the oil phase further includes an auxiliary solvent.

<16> The method for producing microcapsule according to any one of <8> to <15>, which produces a microcapsule having a coefficient of variation of the particle size distribution of 40% or less.

According to an embodiment of the invention, microcapsules having high monodispersity are provided. According to another embodiment of the invention, a method for producing microcapsules having high monodispersity without using special emulsification facilities is provided.

### DESCRIPTION OF THE PREFERRED EMBODIMENTS

In the present specification, a numerical value range expressed using “to” means a range including the numerical values described before and after the “to” as the minimum value and the maximum value, respectively. In regard to the numerical value ranges described stepwise in the present disclosure, the upper limit or the lower limit described in a certain numerical value range may be replaced with the upper limit or the lower limit of another numerical value range described stepwise. In regard to the numerical value ranges described in the present disclosure, the upper limit or the lower limit described in a certain numerical value range may be replaced with a value shown in the Examples.

According to the present specification, the term “step” is not limited to an independent process, and even in a case in which the step cannot be clearly distinguished from another process, the term is included in the present term as long as a predetermined purpose of the step is achieved.

<Microcapsules>

The microcapsules according to the present disclosure encapsulate a solvent having an SP value of higher than or equal to 8 (cal/cm³)^{1/2} and lower than 10 (cal/cm³)^{1/2} and a molecular weight of from 425 to 3,000.

A microcapsule is configured to include a shell and a core.

Here, the term “shell” refers to the walls of a microcapsule. The shell may be, for example, any resin membrane and is preferably formed of any one of a polyurethane, a polyurea, a polyamide, a polyester, a polycarbonate, a urea-formaldehyde resin, a melamine resin, a polystyrene, a styrene-methacrylate copolymer, a styrene-acrylate copolymer, or a silane-crosslinkable resin or any mixed system of these.

The term “core” refers to the portion encapsulated in the shell. The core of a microcapsule according to the present disclosure includes the solvent according to the present disclosure, and also can optionally include a functional material, an auxiliary solvent, and an additive. The solvent, functional material, auxiliary solvent, and additives according to the present disclosure can be collectively referred to as “core materials”.

In regard to the microcapsules according to the present disclosure, the term “encapsulated” means, more specifically, being encapsulated by the shell of the microcapsule.

According to the present disclosure, it is preferable that the microcapsules have an average primary particle size of more than or equal to 1 μm and less than 1,000 μm. The particle size of the microcapsules can be measured using any measuring equipment, for example, MICROTRAC MT3300EXII (manufactured by Nikkiso Co., Ltd.).

Regarding the microcapsules, as the particle size distribution is more monodispersed, it is easier to control the functions to be exhibited, and therefore, it is preferable. However, upon making the particle size distribution monodispersed as such, there has been a problem that special emulsification facilities are required.

In this regard, in the present disclosure, microcapsules having high monodispersity can be obtained by limiting the SP value and the molecular weight of the solvent that constitutes the core of the microcapsules to particular ranges, and in the production of microcapsules, microcapsules having high monodispersity can be produced without using special emulsification facilities.

The reason for this is not clearly known; however, the reason is speculated to be as follows. That is, it is speculated that by adjusting the SP value of the solvent that constitutes the oil phase to a particular range, a balance is achieved between hydrophilicity-hydrophobicity and the intermolecular forces between the oil phase and the aqueous phase, and the size of the emulsion is maintained in a constant range. Furthermore, it is speculated that by adjusting the molecular weight of the solvent to a particular range, volatilization of the solvent is suppressed, the size of the emulsion is maintained in a constant range, and thereby microcapsules having high monodispersity are formed.

The thickness of the shell may vary depending on various conditions such as the type of the shell and the size of the microcapsules; however, for example, the thickness is preferably 0.01 μm to 2.0 μm, more preferably 0.05 μm to 2.0 μm, and even more preferably 0.10 μm to 2.0 μm. As the thickness of the shell is in the range of 0.01 μm to 2.0 μm, for example, functions of the microcapsules such as responsiveness to stimulation are preferably exhibited.

The thickness of the shell refers to an average value obtained by determining the thicknesses (μm) of individual shells of five microcapsules by scanning electron microscopy (SEM) and averaging the thicknesses.

Specifically, a microcapsule liquid is applied on any support and dried, and thereby a coating film is formed. The thickness can be determined by producing cross-sectional slices of the coating film thus obtained, observing the cross-sections using SEM, selecting any five microcapsules, observing the cross-sections of those individual microcapsules, measuring the thicknesses of the shell, and calculating the average value thereof.

The volume-standard median diameter (D50) of the microcapsules is preferably 1 μm to 50 μm, more preferably 5 μm to 30 μm, and even more preferably 10 μm to 20 μm. The volume-standard median diameter of the microcapsules can be preferably controlled by changing at least one of the SP value or the molecular weight of the solvent according to the present disclosure, changing the conditions for dispersing, and the like.

Here, the volume-standard median diameter (D50) of the microcapsules refers to the diameter at which, in a case in which the entirety of the microcapsules is divided into two groups by taking the particle size that gives a volume-based 50% cumulative sum as the threshold, the sums of the particle volumes on the larger diameter side and on the smaller diameter side are equal.

According to the present disclosure, the volume-standard median diameter of the microcapsules is measured using a MICROTRAC MT3300EXII (manufactured by Nikkiso Co., Ltd.).

For the microcapsules according to the present disclosure, the phrase “having high monodispersity” means that the range of the particle size distribution is narrow (that is, the fluctuation of the particle size is small), and the phrase “having low monodispersity” means that the range of the particle size distribution is wide (that is, the fluctuation of the particle size is large).

More specifically, the magnitude of the monodispersity of the microcapsules can be expressed using a CV value (coefficient of variation). Here, the CV value is a value that can be determined by the following formula:

CV value (%)=(Standard deviation/volume average particle size)×100

As the CV value is lower, the monodispersity of the microcapsules is higher, and as the CV value is higher, the monodispersity of the microcapsules is found to be lower.

According to the present disclosure, the volume average particle size and the standard deviation are calculated using a MICROTRAC MT3300EXII (manufactured by Nikkiso Co., Ltd.).

For example, it can be implied by the microcapsules having “high monodispersity” that the CV value of the particle size distribution of the microcapsules is preferably 40% or less, more preferably 35% or less, even more preferably 30% or less, and most preferably 25% or less. In a case in which the CV value is in the above-described range, since the monodispersity of the particle size of the microcapsules is high, handling of the microcapsules, control of the exhibition of functions, and the like are made easier.

Regarding the form of the microcapsules, the microcapsules may be in the form of, for example, a microcapsule dispersion liquid, and preferably an aqueous dispersion liquid of microcapsules.

[Solvent]

The solvent according to the present disclosure has an SP value of greater than or equal to 8 (cal/cm³)^{1/2} and less than 10 (cal/cm³)^{1/2} and has a molecular weight of from 425 to 3,000. The solvent according to the present disclosure is a hydrophobic solvent and forms the core of the microcapsules according to the present disclosure. The microcapsules according to the present disclosure encapsulate a solvent having the SP value and the molecular weight according to the present disclosure in the shell, and have high monodispersity.

(SP Value)

The SP value (Solubility Parameter) is a numerical value defined as the square root of the cohesive energy density and can be regarded as a quantitative expression of polarity. The SP value implies such that as the value is larger, it is more hydrophilic, and as the value is smaller, it is more hydrophobic. The SP value according to the present disclosure is a numerical value calculated by the Okitsu method (Toshinao Okitsu, “Journal of the Adhesion Society of Japan” 29(3) (1993)), and the unit is “(cal/cm³)^{1/2}”.

For the unit of the SP value, it is general to use “(cal/cm³)^{1/2}”, and this is also used in the present disclosure; however, the unit can be converted to the SI unit system by utilizing the conversion formula: “1 (cal/cm³)^{1/2}=2.046 (MPa)^{1/2}=2.046 (J/cm³)^{1/2}”.

The SP value of the solvent according to the present disclosure is greater than or equal to 8 (cal/cm³)^{1/2} and less than 10 (cal/cm³)^{1/2}; preferably from 8.3 (cal/cm³)^{1/2} to 9.5 (cal/cm³)^{1/2}; and more preferably from 8.5 (cal/cm³)^{1/2} to 9.5 (cal/cm³)^{1/2}.

In a case in which the SP value of the solvent is greater than or equal to 8 (cal/cm³)^{1/2} and less than 10 (cal/cm³)^{1/2}, a balance is achieved between hydrophilicity-hydrophobicity and intermolecular forces between the oil phase and the aqueous phase, the size of the emulsion is maintained in a constant range, and thus the monodispersity of the microcapsules becomes high.

(Molecular Weight)

The molecular weight of the solvent according to the present disclosure is from 425 to 3,000, preferably from 425 to 2,500, more preferably from 450 to 2,000, and even more preferably from 1,000 to 1,500.

In a case in which the molecular weight of the solvent is 425 or more, the solvent that forms the core of the microcapsules is not easily volatilized in the production process, and the monodispersity of the microcapsules thus produced becomes high. On the other hand, in a case in which the molecular weight of the solvent is 3,000 or less, an undesirable state such as solidification of the oil phase can be avoided, and therefore, the monodispersity of the microcapsules thus produced becomes high.

The solvent is preferably in an amount of from 30% by mass to 100% by mass, more preferably from 50% by mass to 99% by mass, and even more preferably from 60% by mass to 95% by mass, with respect to the total mass of the core material.

(Ester Obtained by Condensation of Polyol and Fatty Acid)

The solvent according to the present disclosure is preferably an ester obtained by condensation of a polyol and a fatty acid. Such an ester is preferable because in a case in which the molecular weight is from 425 to 3,000, the SP value easily tends to be greater than or equal to 8 (cal/cm³)^{1/2} and less than 10 (cal/cm³)^{1/2}.

Polyol

A polyol is a molecule having an arbitrary structure having two or more hydroxyl groups per molecule. It is preferable that the polyol has three or more hydroxyl groups per molecule, and for example, the polyol may have four hydroxyl groups per molecule, or may have eight hydroxyl groups per molecule. Such a polyol is preferable in a case in which the polyol forms an ester with a fatty acid, because in a case in which the molecular weight is from 425 to 3,000, the SP value easily tends to be greater than or equal to 8 (cal/cm³)^{1/2} and less than 10 (cal/cm³)^{1/2}.

The polyol may be any synthetic or natural polyol, and may be a molecule having a linear, branched, or cyclic structure. Examples of the polyol include ethylene glycol, polyethylene glycol (degree of polymerization is desirably 2, 3, 4, 5, or 6), propylene glycol, polypropylene glycol (degree of polymerization is desirably 2, 3, 4, 5, or 6), neopentyl glycol, 3-methyl-1,3-butanediol, 1,3-butylene glycol, isoprene glycol, 1,2-pentanediol, 1,2-hexanediol, glycerin, polyglycerin (degree of polymerization may be 2, 3, 4, 5, or 6), and pentaerythritol. Preferably, the polyol is polyglycerin (degree of polymerization may be 2, 3, 4, 5, or 6).

In the polyol, all of the hydroxyl groups of the compound may form esters with fatty acids, or only a portion of the hydroxyl groups may form esters with fatty acids. However, since the existence of hydroxyl groups tends to increase the SP value, it is preferable that all of the hydroxyl groups of the polyol form esters with fatty acids.

The various hydroxyl groups of the polyol may each independently form an ester with a fatty acid having the same number of carbon atoms, or may form esters with fatty acids having different numbers of carbon atoms.

Fatty Acid

The fatty acid may be a fatty acid having any number of carbon atoms. The fatty acid is preferably, for example, a fatty acid having 2 to 30 carbon atoms, more preferably a fatty acid having 2 to 20 carbon atoms, even more preferably a fatty acid having 6 to 16 carbon atoms, and most preferably a fatty acid having 8 to 12 carbon atoms. Such a fatty acid is preferable because, as the fatty acid forms an ester with a polyol, in a case in which the molecular weight is from 425 to 3,000, the SP value easily tends to be greater than or equal to 8 (cal/cm³)^{1/2} and less than 10 (cal/cm³)^{1/2}.

The fatty acid may have a linear, branched, or cyclic molecular structure, and may be either saturated or unsaturated. Preferable examples of the fatty acid include acetic acid, propionic acid, butyric acid, valeric acid, caproic acid, 2-ethylhexanoic acid, enanthic acid, caprylic acid, pelargonic acid, capric acid, lauric acid, myristic acid, pentadecanoic acid, palmitic acid, palmitoleic acid, margaric acid, stearic acid, isostearic acid, oleic acid, vaccenic acid, linoleic acid, linolenic acid, eleostearic acid, arachidic acid, mead acid, arachidonic acid, behenic acid, lignoceric acid, nervonic acid, cerotic acid, montanic acid, and melissic acid.

Ester

Examples of the ester obtained by condensation of a polyol and a fatty acid include an ester of ethylene glycol and a fatty acid having 2 to 30 carbon atoms, an ester of a polyethylene glycol (degree of polymerization may be 2, 3, 4, 5, or 6) and a fatty acid having 2 to 30 carbon atoms, an ester of propylene glycol and a fatty acid having 2 to 30 carbon atoms, an ester of a polypropylene glycol (degree of polymerization may be 2, 3, 4, 5, or 6) and a fatty acid having 2 to 30 carbon atoms, an ester of neopentyl glycol and a fatty acid having 2 to 30 carbon atoms, an ester of 3-methyl-1,3-butanediol and a fatty acid having 2 to 30 carbon atoms, an ester of 1,3-butylene glycol and a fatty acid having 2 to 30 carbon atoms, an ester of isoprene glycol and a fatty acid having 2 to 30 carbon atoms, an ester of 1,2-pentanediol and a fatty acid having 2 to 30 carbon atoms, an ester of 1,2-hexanediol and a fatty acid having 2 to 30 carbon atoms, an ester of glycerin and a fatty acid having 2 to 30 carbon atoms, an ester of a polyglycerin (degree of polymerization may be 2, 3, 4, 5, or 6) and a fatty acid having 2 to 30 carbon atoms, and an ester of pentaerythritol and a fatty acid having 2 to 30 carbon atoms. The fatty acid having 2 to 30 carbon atoms may be, for example, a fatty acid having 2 to 20 carbon atoms, a fatty acid having 6 to 16 carbon atoms, or a fatty acid having 8 to 12 carbon atoms.

Regarding the ester obtained by condensation of a polyol and a fatty acid, for example, polyglyceryl-6 octacaprylate [for example, SALACOS (registered trademark) HG-8 manufactured by Nisshin Oillio Group, Ltd.], trimyristin, propanediol diisostearate [for example, SALACOS (registered trademark) PR-17 manufactured by Nisshin Oillio Group, Ltd.], propylene glycol dilaurate [for example, EMALEX (registered trademark) PG-di-L manufactured by Nihon Emulsion Co., Ltd.], glyceryl tri(caprylate/caprate) (“caprylate/caprate” means that any one of caprylic acid or capric acid is bonded to three hydroxyl groups of glycerin) [for example, SKHOLE (registered trademark) 8 manufactured by Nisshin Oillio Group, Ltd.], pentaerythrityl tetraethylhexanoate [SALACOS (registered trademark) 5408 manufactured by Nisshin Oillio Group, Ltd.], or any combination of these is preferable.

Specific examples of the ester preferable as the solvent according to the present disclosure include the following compounds.

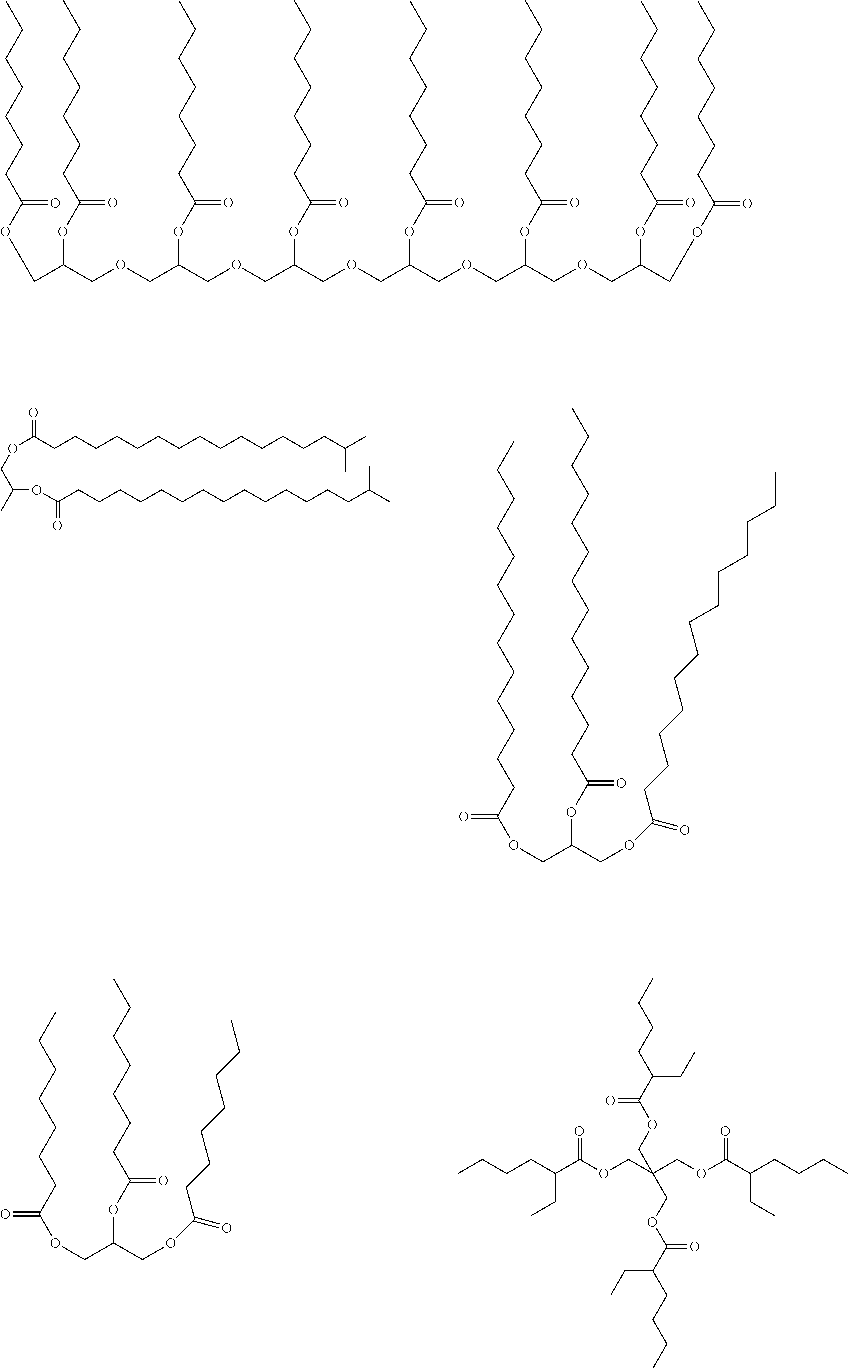 [SMILES: CCCCCCCC(=O)OCC(COCC(COCC(COCC(COCC(COCC(COC(=O)CCCCCCC)OC(=O)CCCCCCC)OC(=O)CCCCCCC)OC(=O)CCCCCCC)OC(=O)CCCCCCC)OC(=O)CCCCCCC)OC(=O)CCCCCCC ; CC(C)CCCCCCCCCCCCCCC(=O)OCC(C)OC(=O)CCCCCCCCCCCCCCC(C)C ; CCCCCCCCCCCCCC(=O)OCC(COC(=O)CCCCCCCCCCCCC)OC(=O)CCCCCCCCCCCCC ; CCCCCCCC(=O)OCC(COC(=O)CCCCCCC)OC(=O)CCCCCCC ; CCCCC(CC)C(=O)OCC(COC(=O)C(CC)CCCC)(COC(=O)C(CC)CCCC)COC(=O)C(CC)CCCC]

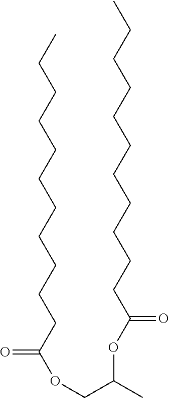 [SMILES: CCCCCCCCCCCC(=O)OCC(C)OC(=O)CCCCCCCCCCC]

The content of the solvent according to the present disclosure is preferably, for example, 30% by mass to 99.9% by mass, more preferably 50% by mass to 97% by mass, and even more preferably 60% by mass to 95% by mass, with respect to the total mass of the core material.

The microcapsules encapsulate the solvent according to the present disclosure and can optionally further encapsulate at least one of a functional material, an auxiliary solvent, or an additive.

(Functional Material)

The functional material according to the present disclosure can be encapsulated into the microcapsules, as necessary. The functional material can be protected from an external environment by being encapsulated in the microcapsules, and release thereof can be controlled by specific stimulation (for example, stress or heat).

Examples of the functional material according to the present disclosure include a fragrance, a dye, a heat storage material, a pharmaceutical component, a cosmetic component, an ink, an adhesive, a curing agent, and a foaming agent; however, the functional material is not limited to these.

The content of the functional material is, for example, preferably 0.1% by mass to 70% by mass, more preferably 1% by mass to 50% by mass, and even more preferably 5% by mass to 40% by mass, with respect to the total mass of the core material.

(Auxiliary Solvent)

An auxiliary solvent can be used, if necessary, in order to dissolve the shell material in the core material. Examples of the auxiliary solvent include ketone-based compounds such as methyl ethyl ketone; ester-based compounds such as ethyl acetate; and alcohol-based compounds such as isopropyl alcohol. Preferably, the auxiliary solvent has a boiling point of 130° C. or lower.

The content of the auxiliary solvent is, for example, preferably 0% by mass to 20% by mass, more preferably 1% by mass to 15% by mass, and even more preferably 5% by mass to 10% by mass, with respect to the total mass of the core material.

(Additives)

Additives can be encapsulated by the microcapsules, as necessary. Specific examples of the additives include an ultraviolet absorber, a photostabilizer, an antioxidant, a wax, and a foul odor inhibitor.

The content of the additives is, for example, preferably 0% by mass to 20% by mass, more preferably 1% by mass to 15% by mass, and even more preferably 5% by mass to 10% by mass, with respect to the total mass of the core material.

An aspect in which the microcapsules encapsulate the solvent according to the present disclosure, a functional material, and an auxiliary solvent as the core material is preferred. In the case of this aspect, the content of the solvent according to the present disclosure is 60% by mass to 80% by mass with respect to the total mass of the core material; the content of the functional material is 15% by mass to 30% by mass with respect to the total mass of the core material; and the auxiliary solvent is preferably 5% by mass to 10% by mass with respect to the total mass of the core material.

<Method for Producing Microcapsules>

A method for producing microcapsules according to the present disclosure includes a step of dispersing an oil phase including a solvent having an SP value of greater than or equal to 8 (cal/cm³)^{1/2} and less than 10 (cal/cm³)^{1/2} and a molecular weight of from 425 to 3,000; and a shell material in an aqueous phase including an emulsifier and preparing an emulsion (hereinafter, also referred to as emulsification step); and a step of polymerizing the shell material at the interface between the oil phase and the aqueous phase to form a shell, and forming microcapsules encapsulating the solvent (hereinafter, also referred to as capsulation step).

By including these steps, microcapsules having high monodispersity can be obtained by the method for producing microcapsules according to the present disclosure.

[Emulsification Step]

The method for producing microcapsules according to the present disclosure includes a step of dispersing an oil phase including a solvent and a shell material, the solvent having an SP value of greater than or equal to 8 (cal/cm³)^{1/2} and less than 10 (cal/cm³)^{1/2} and a molecular weight of from 425 to 3,000, in an aqueous phase including an emulsifier, and thereby preparing an emulsion.

In the oil phase according to the present disclosure, since a solvent having an SP value of greater than or equal to 8 (cal/cm³)^{1/2} and less than 10 (cal/cm³)^{1/2} and a molecular weight of from 425 to 3,000 is included, the oil phase (oil droplets) dispersed in the emulsion achieves a balance with the aqueous phase between hydrophilicity-hydrophobicity and intermolecular forces, and the fluctuation in the size of the oil droplets becomes smaller. Thus, the monodispersity of the microcapsules can be increased.

(Emulsion)

The emulsion according to the present disclosure is formed by dispersing an oil phase including a solvent having an SP value of greater than or equal to 8 (cal/cm³)^{1/2} and less than 10 (cal/cm³)^{1/2} and a molecular weight of from 425 to 3,000; and a shell material, in an aqueous phase including an emulsifier.

Oil Phase

In the oil phase according to the present disclosure, a solvent having an SP value of greater than or equal to 8 (cal/cm³)^{1/2} and less than 10 (cal/cm³)^{1/2} and a molecular weight of from 425 to 3,000, and a shell material are included.

In the oil phase according to the present disclosure, the solvent according to the present disclosure and a shell material are included, and if necessary, at least one of a functional material, an auxiliary solvent, or an additive may be further included. The functional material, the auxiliary solvent, and the additive that can be used for the oil phase are as described in the section <Microcapsules>.

Solvent

The solvent used for the production method according to the present disclosure is as described in the section <Microcapsules>.

Shell Material

The shell material according to the present disclosure refers to a substance that can form the shell of microcapsules by polymerization. Preferably, the shell material includes an organic polyisocyanate and a polyol having a polyester structure or a polyether structure, polymethylene diisocyanate and polymethylenediamine, urea and polymethylenediamine, an amide or a polyol and a fatty acid, an aromatic or aliphatic dihydroxy compound and phosgene, urea and formaldehyde, melamine and an aliphatic aldehyde, styrene, styrene and methacrylic acid, styrene and acrylic acid, an alkoxysilane compound, or any combination of these.

The content of the shell material in the oil phase is, for example, preferably more than 0.1% by mass and less than or equal to 20% by mass, more preferably 0.5% by mass to 10% by mass, and even more preferably 1% by mass to 5% by mass, with respect to the total mass of the oil phase.

The content of the shell material in the oil phase can be adjusted as appropriate in view of the size of the microcapsules, wall thickness, and the like.

(Aqueous Phase)

The aqueous phase according to the present disclosure includes an aqueous medium and an emulsifier.

Aqueous Medium

The aqueous medium according to the present disclosure is preferably water.

The content of the aqueous medium is preferably 20% by mass to 80% by mass, more preferably 30% by mass to 70% by mass, and even more preferably 40% by mass to 60% by mass, with respect to the total mass of the emulsion, which is a mixture of the oil phase and the aqueous phase.

Emulsifier

Examples of the emulsifier include a dispersant, a surfactant, or a combination thereof.

Examples of the dispersant include polyvinyl alcohol and modification products thereof, polyacrylic acid amide and derivatives thereof, an ethylene-vinyl acetate copolymer, a styrene-maleic anhydride copolymer, an ethylene-maleic anhydride copolymer, an isobutylene-maleic anhydride copolymer, polyvinylpyrrolidone, an ethylene-acrylic acid copolymer, a vinyl acetate-acrylic acid copolymer, carboxymethyl cellulose, methyl cellulose, casein, gelatin, starch derivatives, gum arabic, and sodium alginate, and polyvinyl alcohol (hereinafter, also referred to as PVA) is preferred.

It is preferable that these dispersants do not react with the shell material or react with the shell material with extreme difficulties, and for example, a dispersant having a reactive amino group in the molecular chain, such as gelatin, needs to be treated in advance to lose reactivity.

Examples of the surfactant include a nonionic surfactant, an anionic surfactant, a cationic surfactant, and an amphoteric surfactant. The surfactant may be used singly, or two or more kinds thereof may be used in combination.

The nonionic surfactant is not particularly limited, and any conventionally known agent can be used. Examples of the nonionic surfactant include a polyoxyethylene alkyl ether-based compound, a polyoxyethylene alkyl phenyl ether-based compound, a polyoxyethylene polystyryl phenyl ether-based compound, a polyoxyethylene polyoxypropylene alkyl ether-based compound, a glycerin fatty acid partial ester-based compound, a sorbitan fatty acid partial ester-based compound, a pentaerythritol fatty acid partial ester-based compound, a propylene glycol monofatty acid ester-based compound, a sucrose fatty acid partial ester-based compound, a polyoxyethylene sorbitan fatty acid partial ester-based compound, a polyoxyethylene sorbitol fatty acid partial ester-based compound, a polyethylene glycol fatty acid ester-based compound, a polyglycerin fatty acid partial ester-based compound, a polyoxyethylenated castor oil-based compound, a polyoxyethylene glycol fatty acid partial ester-based compound, a fatty acid diethanolamide-based compound, an N,N-bis-2-hydroxyalkylamine-based compound, a polyoxyethylenealkylamine, a triethanolamine fatty acid ester, a trialkylamine oxide, polyethylene glycol, and a copolymer of polyethylene glycol and polypropylene glycol.

The anionic surfactant is not particularly limited, and any conventionally known agent can be used. Examples of the anionic surfactant include a fatty acid salt, an abietic acid salt, a hydroxyalkane sulfonic acid salt, an alkane sulfonic acid salt, a dialkylsulfosuccinic acid ester salt, a straight-chained alkylbenzene sulfonic acid salt, a branched alkylbenzene sulfonic acid salt, an alkylnaphthalenesulfonic acid salt, an alkylphenoxy polyoxyethylene propyl sulfonic acid salt, a polyoxyethylene alkylsulfophenyl ether salt, an N-methyl-N-oleyltaurine sodium salt, an N-alkylsulfosuccinic acid monoamide disodium salt, a petroleum sulfonic acid salt, a sulfated beef tallow oil, a sulfuric acid ester salt of a fatty acid alkyl ester, an alkyl sulfuric acid ester salt, a polyoxyethylene alkyl ether sulfuric acid ester salt, a fatty acid monoglyceride sulfuric acid ester salt, a polyoxyethylene alkyl phenyl ether sulfuric acid ester salt, a polyoxyethylene styryl phenyl ether sulfuric acid ester salt, an alkyl phosphoric acid ester salt, a polyoxyethylene alkyl ether phosphoric acid ester salt, a polyoxyethylene alkyl phenyl ether phosphoric acid ester salt, a partial saponification product of a styrene-maleic anhydride copolymer, a partial saponification product of an olefin-maleic anhydride copolymer, a naphthalenesulfonic acid salt-formalin condensate, a salt of an alkyl polyoxyalkylene sulfoalkyl ether, and a salt of an alkenyl polyoxyalkylene sulfoalkyl ether.

The cationic surfactant is not particularly limited, and any conventionally known agent can be used. Examples of the cationic surfactant include an alkylamine salt, a quaternary ammonium salt (for example, hexadecyltrimethylammonium chloride), a polyoxyethylene alkylamine salt, and a polyethylene polyamine derivative.

The amphoteric surfactant is not particularly limited, and any conventionally known agent can be used. Examples of the amphoteric surfactant include carboxybetaine, an aminocarboxylic acid, sulfobetaine, an aminosulfuric acid ester, and imidazoline.

The concentration (that is, content) of the emulsifier is preferably more than 0% by mass and less than or equal to 20% by mass, more preferably from 0.005% by mass to 10% by mass, even more preferably from 0.01% by mass to 10% by mass, and most preferably from 1% by mass to 5% by mass, with respect to the total mass of the emulsion, which is a mixture of the oil phase and the aqueous phase.

The aqueous phase may contain other components such as an ultraviolet absorber, an antioxidant, and a preservative, if necessary.

The content of the other components is, for example, preferably more than 0% by mass and less than or equal to 20% by mass, more preferably more than 0.1% by mass and less than or equal to 15% by mass, and even more preferably more than 1% by mass and less than or equal to 10% by mass, with respect to the total mass of the aqueous phase.

(Dispersion)

Dispersion refers to a process of dispersing the oil phase according to the present disclosure as oil droplets in the aqueous phase according to the present disclosure (that is, emulsifying dispersion). Dispersion can be carried out using a means that is conventionally used for dispersing of an oil phase and an aqueous phase, for example, a homogenizer, a MANTON-GAULIN, an ultrasonic dispersing machine, a dissolver, a KADY mill, or another known dispersing apparatus.

The mixing ratio of the oil phase to the aqueous phase (that is, oil phase mass/aqueous phase mass) is preferably 0.1 to 1.5, more preferably 0.2 to 1.2, and even more preferably 0.4 to 1.0. The mixing ratio (that is, oil phase mass/aqueous phase mass) is in the range of 0.1 to 1.5, the emulsion can be maintained at an appropriate viscosity, excellent production suitability is obtained, and the emulsion has excellent stability.

[Capsulation Step]

The method for producing microcapsules according to the present disclosure includes a step of polymerizing the shell material at the interface between the oil phase and the aqueous phase to form a shell, and forming microcapsules that encapsulate a solvent. Thereby, microcapsules having the solvent according to the present disclosure encapsulated in the shell are formed.

(Polymerization)

Polymerization is a process of polymerizing the shell material included in the oil phase in the emulsion at the interface between the oil phase and the aqueous phase, and a shell is formed by this process. Polymerization is preferably carried out under heating. The reaction temperature for the polymerization may vary depending on the type of the shell material or the like; however, usually, the reaction temperature is preferably 40° C. to 100° C., and more preferably 50° C. to 80° C. Furthermore, the reaction time for polymerization also varies similarly depending on the type of the shell material or the like; however, usually, the reaction time is preferably about 0.5 hours to 10 hours, and more preferably about 1 hour to 5 hours. As the polymerization temperature is higher, the polymerization time becomes shorter; however, in the case of using an inclusion or a shell material, for which there is a risk of being decomposed at high temperature, it is desirable to select a polymerization initiator that acts at low temperature and to perform polymerization at a relatively low temperature. For example, in a case in which an alkoxysilane compound is used as the shell material, the polymerization temperature is preferably 15° C. to 40° C., and more preferably 20° C. to 30° C., and the reaction time is preferably 1 hour to 40 hours, and more preferably 5 hours to 30 hours.

In order to prevent aggregation between microcapsules during polymerization, it is preferable that an aqueous solution (for example, water or an aqueous solution of acetic acid) is further added to thereby decrease the probability of collision between the microcapsules, and it is also preferable to perform sufficient stirring. It is also acceptable to add a dispersant for preventing aggregation again during polymerization. Furthermore, if necessary, a charge adjusting agent such as nigrosin, or any other auxiliary agent can be added. These auxiliary agents can be added at the time of forming the shell, or at any time point.

The microcapsules produced by the production method according to the present disclosure are as described in the section <Microcapsules>.

### EXAMPLES

Hereinafter, the invention will be described more specifically by way of Examples; however, the invention is not intended to be limited to the following Examples as long as the main gist is maintained.

### Example 1

28.7 parts by mass of SALACOS (registered trademark) HG-8 (manufactured by Nisshin Oillio Group, Inc., SP value of 9.3 (cal/cm³)^{1/2}, molecular weight of 1,375, an ester obtained by condensation of a fatty acid having 8 carbon atoms and a polygycerin having 8 hydroxyl groups) as a solvent, 9.4 parts by mass of D-limonene (manufactured by Yasuhara Chemical Co., Ltd., fragrance) as a functional material, 0.1 parts by mass of ADEKA POLYETHER EDP-300 (manufactured by Adeka Corporation, polyether polyol) and 0.9 parts by mass of BURNOCK (registered trademark) D-750 (manufactured by DIC Corporation, polyisocyanate) as shell materials, and 3.0 parts by mass of ethyl acetate (manufactured by Sankyo Chemical Co., Ltd.) as an auxiliary solvent were used and mixed with stirring, and an oil phase solution was obtained. Furthermore, 3.4 parts by mass of KURARAY POVAL (registered trademark) PVA-217E (manufactured by Kuraray Co., Ltd., PVA) as an emulsifier was added to 54.6 parts by mass of water as an aqueous medium, and the mixture was stirred and mixed. Thus, an aqueous phase solution was obtained. The oil phase solution was added to and dispersed in the aqueous phase solution thus obtained, and then 100.0 parts by mass of water was added to the emulsion thus produced. The mixture was heated to 70° C. and was stirred for one hour and then cooled. Thus, an aqueous dispersion liquid of microcapsules was obtained.

The volume-based median diameter (D50) of the microcapsules thus obtained was 15 μm. Furthermore, the CV value of the particle size distribution [=(standard deviation/volume average particle size)×100] was 22% (Table 1). Meanwhile, the volume-based median diameter, standard deviation, and volume average particle size were measured using a MICROTRAC MT3300EXII (manufactured by Nikkiso Co., Ltd.).

### Example 2 to Example 6

Aqueous dispersion liquids of microcapsules were obtained in the same manner as in Example 1, except that the solvents described in Table 1 were used as the solvent.

The volume-based median diameter, standard deviation, and volume average particle size of the microcapsules thus obtained were measured in the same manner as in Example 1.

The CV values and median diameters of the various Examples were as shown in Table 1.

### Comparative Examples 1 to 4

Aqueous dispersion liquids of microcapsules were obtained in the same manner as in Example 1, except that the solvents described in Table 1 were used as the solvent.

The volume-based median diameter, standard deviation, and volume average particle size of the microcapsules thus obtained were measured in the same manner as in Example 1.

The CV values and median diameters of the various Comparative Examples were as shown in Table 1.

TABLE 1

| | Emulsification step | | | | | | | | | | |
|---|---|---|---|---|---|---|---|---|---|---|---|
| | Oil phase [mass %] | | | | | | | | | | |
| | | | | | | | | | | | Functional |
| | Solvent | | | | | | | | | | material |
| Material | | Tri- | | | | | | | | 1-Methyl- | D-limo- |
| Type | HG-8 | myristin | PR-17 | PG-di-L | SKHOLE-8 | 5408 | EH | Octane | MIBK | imidazole | nene |
| SP value | 9.3 | 8.6 | 8.4 | 8.6 | 9.0 | 8.9 | 9.0 | 7.2 | 8.8 | 10.6 | — |
| [(cal/ | | | | | | | | | | | |
| cm³)^{1/2}] | | | | | | | | | | | |
| Molecular | 1375 | 723 | 609 | 441 | 471 | 641 | 413 | 114 | 100 | 82 | — |
| weight | | | | | | | | | | | |
| Polyol | OH8 | OH3 | OH2 | OH2 | OH3 | OH4 | (OH1) | — | — | — | — |
| Fatty acid | C8 | C14 | C18 | C12 | C8 | C8 | C18 | — | — | — | — |
| Active | 100 | 100 | 100 | 100 | 100 | 100 | 100 | 100 | 100 | 100 | 100 |
| ingredient | | | | | | | | | | | |
| concen- | | | | | | | | | | | |
| tration | | | | | | | | | | | |
| [mass %] | | | | | | | | | | | |
| Example 1 | 28.7 | | | | | | | | | | 9.4 |
| Example 2 | | 28.7 | | | | | | | | | 9.4 |
| Example 3 | | | 28.7 | | | | | | | | 9.4 |
| Example 4 | | | | 28.7 | | | | | | | 9.4 |
| Example 5 | | | | | 28.7 | | | | | | 9.4 |
| Example 6 | | | | | | 28.7 | | | | | 9.4 |
| Comparative | | | | | | | 28.7 | | | | 9.4 |
| Example 1 | | | | | | | | | | | |
| Comparative | | | | | | | | 28.7 | | | 9.4 |
| Example 2 | | | | | | | | | | | |
| Comparative | | | | | | | | | 28.7 | | 9.4 |
| Example 3 | | | | | | | | | | | |
| Comparative | | | | | | | | | | 28.7 | 9.4 |
| Example 4 | | | | | | | | | | | |

| | | | | | | | | Capsu- | | |
|---|---|---|---|---|---|---|---|---|---|---|
| | | | | | | | | lation | | |
| | Emulsification step | | | | | | | step | | |
| | Oil phase [mass %] | | | Aqueous phase | | | Emul- | Aqueous | | |
| | Shell | | Auxiliary | [mass %] | | | sifier | solution | | |
| | material | | solvent | Emul- | Aqueous | | concen- | [mass %] | CV | Median |
| Material | EDP- | D- | Ethyl | sifier | medium | Total | tration | Others | value | diameter |
| Type | 300 | 750 | acetate | 217E | Water | [mass %] | [mass %] | Water | [%] | [μm] |
| SP value | — | — | — | — | — | | | — | | |
| [(cal/ | | | | | | | | | | |
| cm³)^{1/2}] | | | | | | | | | | |
| Molecular | — | — | — | — | — | | | — | | |
| weight | | | | | | | | | | |
| Polyol | — | — | — | — | — | | | — | | |
| Fatty acid | — | — | — | — | — | | | — | | |
| Active | 100 | 75 | 100 | 100 | 100 | | | 100 | | |
| ingredient | | | | | | | | | | |
| concen- | | | | | | | | | | |
| tration | | | | | | | | | | |
| [mass %] | | | | | | | | | | |
| Example 1 | 0.1 | 0.9 | 3.0 | 3.4 | 54.6 | 100.0 | 3.4 | 100.0 | 22 | 15 |
| Example 2 | 0.1 | 0.9 | 3.0 | 3.4 | 54.6 | 100.0 | 3.4 | 100.0 | 33 | 15 |
| Example 3 | 0.1 | 0.9 | 3.0 | 3.4 | 54.6 | 100.0 | 3.4 | 100.0 | 38 | 15 |
| Example 4 | 0.1 | 0.9 | 3.0 | 3.4 | 54.6 | 100.0 | 3.4 | 100.0 | 36 | 15 |
| Example 5 | 0.1 | 0.9 | 3.0 | 3.4 | 54.6 | 100.0 | 3.4 | 100.0 | 27 | 15 |
| Example 6 | 0.1 | 0.9 | 3.0 | 3.4 | 54.6 | 100.0 | 3.4 | 100.0 | 27 | 15 |
| Comparative | 0.1 | 0.9 | 3.0 | 3.4 | 54.6 | 100.0 | 3.4 | 100.0 | 43 | 15 |
| Example 1 | | | | | | | | | | |
| Comparative | 0.1 | 0.9 | 3.0 | 3.4 | 54.6 | 100.0 | 3.4 | 100.0 | 55 | 15 |
| Example 2 | | | | | | | | | | |
| Comparative | 0.1 | 0.9 | 3.0 | 3.4 | 54.6 | 100.0 | 3.4 | 100.0 | 48 | 15 |
| Example 3 | | | | | | | | | | |
| Comparative | 0.1 | 0.9 | 3.0 | 3.4 | 54.6 | 100.0 | 3.4 | 100.0 | No | No |
| Example 4 | | | | | | | | | capsule | capsule |
| | | | | | | | | | formation | formation |

The details of the various components described in Table 1 to Table 3 are as follows. In Table 1 to Table 3, the number of hydroxyl groups per molecule of the polyol is described in the section for polyol, and the number of carbon atoms of the fatty acid is described in the section for fatty acid. Furthermore, the active ingredient concentration in Table 1 to Table 3 refers to the concentration of various active ingredients (that is, solvent, functional material, shell material, auxiliary solvent, aqueous medium, or other components) included in the manufactured product.

Solvent
HG-8: SALACOS (registered trademark) HG-8 manufactured by Nisshin Oillio Group, Inc., polyglyceryl-6 octacaprylate, an ester of a polyol having 8 hydroxyl groups per molecule (that is, polyglycerin) and a fatty acid having 8 carbon atoms
Trimyristin: manufactured by Tokyo Chemical Industry Co., Ltd., an ester of a polyol having 3 hydroxyl groups per molecule and a fatty acid having 14 carbon atoms
PR-17: SALACOS (registered trademark) PR-17 manufactured by Nisshin Oillio Group, Inc., propanediol diisostearate, an ester of a polyol having 2 hydroxyl groups per molecule and a fatty acid having 18 carbon atoms
PG-di-L: EMALEX (registered trademark) PG-di-L manufactured by Nihon Emulsion Co., Ltd., propylene glycol dilaurate, an ester of a polyol having 2 hydroxyl groups per molecule and a fatty acid having 12 carbon atoms
SKHOLE 8: SKHOLE (registered trademark) 8 manufactured by Nisshin Oillio Group, Inc., glyceryl (tricaprylate/caprate), an ester of a polyol having 3 hydroxyl groups per molecule (that is, monoglycerin) and a fatty acid having 8 carbon atoms
5408: SALACOS (registered trademark) 5408 manufactured by Nisshin Oillio Group, Inc., pentaerythrityl tetraethylhexanoate, an ester of a polyol having 4 hydroxyl groups per molecule (that is, pentaerythritol) and a fatty acid having 8 carbon atoms
EH: SALACOS (registered trademark) EH manufactured by Nisshin Oillio Group, Inc., ethylhexyl hydroxystearate, an ester of a polyol having one hydroxyl group per molecule and a fatty acid having 18 carbon atoms
Octane: manufactured by Tokyo Chemical Industry Co., Ltd.
MIBK: manufactured by Mitsubishi Chemical Corporation, methyl isobutyl ketone
1-Methylimidazole: manufactured by Tokyo Chemical Industry Co., Ltd.

Functional Material
D-limonene: manufactured by Yasuhara Chemical Co., Ltd., fragrance
I-6B: Pergascript Red I-6B manufactured by BASF SE, dye
Octadecane: manufactured by Tokyo Chemical Industry Co., Ltd., heat storage agent
479: Tinuvin (registered trademark) 479 manufactured by BASF SE, ultraviolet absorber

Shell Material
EDP-300: ADEKA POLYETHER EDP-300 manufactured by Adeka Corporation, polyether polyol
D-750: BURNOCK (registered trademark) D-750 manufactured by DIC Corporation, polyisocyanate
750LM: NIKALAC (registered trademark) MX-750LM manufactured by Sanwa Chemical Co., Ltd., methylated melamine resin
KBE-04: manufactured by Shin-Etsu Chemical Co., Ltd., tetraethoxysilane, alkoxysilane compound
Auxiliary Solvent
Ethyl acetate: manufactured by Tokyo Chemical Industry Co., Ltd.
Emulsifier
217E: KURARAY POVAL PVA-217E manufactured by Kuraray Co., Ltd., dispersant
CTAC: manufactured by Tokyo Chemical Industry Co., Ltd., hexadecyltrimethylammonium chloride, surfactant

### Example 7 to Example 10

Aqueous dispersion liquids of microcapsules were obtained in the same manner as in Example 1, except that for the amount of the dispersant, the amounts described in Table 2 were used, and the amount of water as an aqueous medium was adjusted such that the sum of the oil phase and the aqueous phase would be 100% by mass.

The volume-based median diameter, standard deviation, and volume average particle size of the microcapsules thus obtained were measured in the same manner as in Example 1.

The CV values and median diameters of the various Examples were as shown in Table 2.

TABLE 2

| | | | | | | | | | | Capsu- | | |
|---|---|---|---|---|---|---|---|---|---|---|---|---|
| | | | | | | | | | | lation | | |
| | Emulsification step | | | | | | | | | step | | |
| | Oil phase [mass %] | | | | | Aqueous phase | | | Emul- | Aqueous | | |
| | | | | | Auxiliary | [mass %] | | | sifier | solution | | |
| | | Functional | | | solvent | Emul- | Aqueous | | concen- | [mass %] | CV | Median |
| Material | Solvent | material | Shell material | | Ethyl | sifier | medium | Total | tration | Others | value | diameter |
| Type | HG-8 | D-limonene | EDP-300 | D-750 | acetate | 217E | Water | [mass %] | [mass %] | Water | [%] | [μm] |
| SP value | 9.3 | — | — | — | — | — | — | | | — | | |
| [(cal/ | | | | | | | | | | | | |
| cm³)^{1/2}] | | | | | | | | | | | | |
| Molecular | 1375 | — | — | — | — | — | — | | | — | | |
| weight | | | | | | | | | | | | |
| Polyol | OH8 | — | — | — | — | — | — | | | — | | |
| Fatty acid | C8 | — | — | — | — | — | — | | | — | | |
| Active | 100 | 100 | 100 | 75 | 100 | 100 | 100 | | | 100 | | |
| ingredient | | | | | | | | | | | | |
| concen- | | | | | | | | | | | | |
| tration | | | | | | | | | | | | |
| [mass %] | | | | | | | | | | | | |
| Example 7 | 28.7 | 9.4 | 0.1 | 0.9 | 3.0 | 0.005 | 57.9 | 100.0 | 0.005 | 100.0 | 28 | 15 |
| Example 8 | 28.7 | 9.4 | 0.1 | 0.9 | 3.0 | 0.01 | 57.9 | 100.0 | 0.01 | 100.0 | 24 | 15 |
| Example 9 | 28.7 | 9.4 | 0.1 | 0.9 | 3.0 | 0.1 | 57.8 | 100.0 | 0.1 | 100.0 | 24 | 15 |
| Example 10 | 28.7 | 9.4 | 0.1 | 0.9 | 3.0 | 1.0 | 56.9 | 100.0 | 1.0 | 100.0 | 23 | 15 |

### Example 11 to Example 13

Aqueous dispersion liquids of microcapsules were obtained in the same manner as in Example 1, except that the functional materials described in Table 3 were used as the functional material.

The volume-based median diameter, standard deviation, and volume average particle size of the microcapsules thus obtained were measured in the same manner as in Example 1.

The CV values and the median diameters of the various Examples were as shown in Table 3.

### Example 14

An aqueous dispersion liquid of microcapsules was obtained in the same manner as in Example 1, except that the shell materials described in Table 3 were used as the shell material.

The volume-based median diameter, standard deviation, and volume average particle size of the microcapsules thus obtained were measured in the same manner as in Example 1.

The CV values and the median diameters of Example 14 were as shown in Table 3.

### Example 15

An oil phase solution was obtained in the same manner as in Example 1, except that 0.8 parts by mass of KBE-04 (manufactured by Shin-Etsu Silicones Co., Ltd., alkoxysilane compound) as a shell material, and 3.2 parts by mass of ethyl acetate (manufactured by Sankyo Chemical Co., Ltd.) as an auxiliary solvent were used. Furthermore, 1.0 part by mass of hexadecyltrimethylammonium chloride (manufactured by Tokyo Chemical Industry Co., Ltd., surfactant) as an emulsifier was added to 56.9 parts by mass of water, the mixture was stirred and mixed, and an aqueous phase solution was obtained. The oil phase solution was added to and dispersed in the aqueous phase solution thus obtained, and then 100.0 parts by mass of an aqueous solution of acetic acid (pH 3) was added to the emulsion. The mixture was stirred for 24 hours at 25° C. and then was heated to 50° C., and the mixture was stirred for 3 hours and then was cooled. Thus, an aqueous dispersion liquid of microcapsules was obtained.

The volume-based median diameter (D50) of the microcapsules thus obtained was 15 μm. The CV value of the particle size distribution was 21% (Table 3). The volume-based median diameter, standard deviation, and volume average particle size were measured using a MICROTRAC MT3300EXII (manufactured by Nikkiso Co., Ltd.).

TABLE 3

| | Emulsification step | | | | | | | | | |
|---|---|---|---|---|---|---|---|---|---|---|
| | Oil phase [mass %] | | | | | | | | | |
| | | | | | | | | | | Auxiliary |
| | | Functional material | | | | | | | | solvent |
| Material | Solvent | D-lim- | | Octa- | | Shell material | | | | Ethyl |
| Type | HG-8 | onene | I-6B | decane | 479 | EDP-300 | D-750 | 750LM | KBE-04 | acetate |
| SP value | 9.3 | — | — | — | — | — | — | — | — | — |
| [(cal/ | | | | | | | | | | |
| cm³)^{1/2}] | | | | | | | | | | |
| Molecular | 1375 | — | — | — | — | — | — | — | — | — |
| weight | | | | | | | | | | |
| Polyol | OH8 | — | — | — | — | — | — | — | — | — |
| Fatty acid | C8 | — | — | — | — | — | — | — | — | — |
| Active | 100 | 100 | 100 | 100 | 100 | 100 | 75 | 75 | 100 | 100 |
| ingredient | | | | | | | | | | |
| concen- | | | | | | | | | | |
| tration | | | | | | | | | | |
| [mass %] | | | | | | | | | | |
| Example 11 | 28.7 | | 9.4 | | | 0.1 | 0.9 | | | 3.0 |
| Example 12 | 28.7 | | | 9.4 | | 0.1 | 0.9 | | | 3.0 |
| Example 13 | 28.7 | | | | 9.4 | 0.1 | 0.9 | | | 3.0 |
| Example 14 | 28.7 | 9.4 | | | | | | 1.0 | | 3.0 |
| Example 15 | 28.7 | 9.4 | | | | | | | 0.8 | 3.2 |

| | | | | | | Capsulation step | | | |
|---|---|---|---|---|---|---|---|---|---|
| | | | | | | Aqueous solution | | | |
| | | | | | | [mass %] | | | |
| | Emulsification step | | | | | Others | | | |
| | Aqueous phase | | | | Emul- | | Aqueous | | |
| | [mass %] | | | | sifier | | solution | | |
| | | | Aqueous | | concen- | | of acetic | CV | Median |
| Material | Emulsifier | | medium | Total | tration | | acid | value | diameter |
| Type | 217E | CTAC | Water | [mass %] | [mass %] | Water | (pH 3) | [%] | [μm] |
| SP value | — | — | — | | | — | — | | |
| [(cal/ | | | | | | | | | |
| cm³)^{1/2}] | | | | | | | | | |
| Molecular | — | — | — | | | — | — | | |
| weight | | | | | | | | | |
| Polyol | — | — | — | | | — | — | | |
| Fatty acid | — | — | — | | | — | — | | |
| Active | 100 | 100 | 100 | | | 100 | 100 | | |
| ingredient | | | | | | | | | |
| concen- | | | | | | | | | |
| tration | | | | | | | | | |
| [mass %] | | | | | | | | | |
| Example 11 | 3.4 | | 54.6 | 100.0 | 3.4 | 100.0 | | 22 | 15 |
| Example 12 | 3.4 | | 54.6 | 100.0 | 3.4 | 100.0 | | 22 | 15 |
| Example 13 | 3.4 | | 54.6 | 100.0 | 3.4 | 100.0 | | 22 | 15 |
| Example 14 | 3.4 | | 54.6 | 100.0 | 3.4 | 100.0 | | 22 | 15 |
| Example 15 | | 1.0 | 56.9 | 100.0 | 1.0 | | 100.0 | 21 | 15 |

According to the present disclosure, it was considered that in a case in which the CV value was 40% or lower, the microcapsules had high monodispersity, and in a case in which the CV value was higher than 40%, the microcapsules had low monodispersity.

In Examples 1 to 6, the CV values of the particle size distributions of the microcapsules obtained using six kinds of solvents, all of which had an SP value of greater than or equal to 8 (cal/cm³)^{1/2} and less than 10 (cal/cm³)^{1/2} and a molecular weight of from 425 to 3,000, were investigated.

As a result, it was found that the microcapsules of Examples 1 to 6 all had a CV value of the particle size distribution of 40% or lower, and therefore, the microcapsules had high monodispersity.

In Comparative Examples 1 to 4, the CV values of the microcapsules obtained using solvents that did not satisfy at least one of the requirements of “having an SP value of greater than or equal to 8 (cal/cm³)^{1/2} and less than 10 (cal/cm³)^{1/2}” or “having a molecular weight of from 425 to 3,000”, were investigated.

As a result, it was found that the microcapsules of Comparative Examples 1 to 3 all had a CV value of the particle size distribution of higher than 40%, and the microcapsules had low monodispersity. In Comparative Example 4, it was found that microcapsules were not formed.

As such, it was found that microcapsules having high monodispersity are obtained by using a solvent having an SP value of greater than or equal to 8 (cal/cm³)^{1/2} and less than 10 (cal/cm³)^{1/2} and a molecular weight of from 425 to 3,000 in the oil phase and encapsulating the solvent in the microcapsules.

In Examples 7 to 10, the effect exerted by the concentration of the emulsifier included in the aqueous phase on the CV value was investigated.

As a result, it was found that the CV values of the particle size distribution were all 40% or less, and the emulsifier lowers the CV value of the microcapsules thus produced in a concentration-dependent manner, at least in the range of up to 1.0% by mass with respect to the total mass of the aqueous phase and the oil phase.

In Examples 11 to 13, the change in the CV value in a case in which the type of the functional material to be encapsulated in the microcapsules was changed, was investigated.

As a result, it was found that the CV values of the particle size distribution were all 40% or less, and even in a case in which the functional material was changed, the CV value did not change.

In Example 14, the change in the CV value in a case in which the shell material was changed from an alcohol (that is, polyether polyol) and an isocyanate (that is, polyisocyanate) of Example 1 to melamine, was investigated.

As a result, it was found that the CV value was 22%, similarly to Example 1.

In Example 15, the change in the CV value in a case in which the shell material and emulsifier of the emulsification step, and the aqueous solution of the capsulation step were changed from Example 1, was investigated.

As a result, it was found that the CV value of Example 15 was 21%, and the CV value was slightly lowered compared to the CV value of 22% of Example 1.

As such, it was found that in order to obtain microcapsules having high monodispersity, it is important to use a solvent according to the present disclosure, that is, a solvent having an SP value of greater than or equal to 8 (cal/cm³)^{1/2} and less than 10 (cal/cm³)^{1/2} and a molecular weight of from 425 to 3,000, in the oil phase and to encapsulate the solvent in the microcapsules.

The microcapsules according to the present disclosure can encapsulate functional materials such as a fragrance, a dye, a heat storage material, a pharmaceutical component, a cosmetic component, an ink, an adhesive, a curing agent, and a foaming agent, and can exhibit a variety of preferable functions such as protection of the functional materials and responsiveness to stimulation.

The disclosure of JP2017-063993, filed on Mar. 28, 2017, is incorporated herein in its entirety by reference.

All publications, patent applications, and technical standards mentioned in this specification are herein incorporated by reference to the same extent as if each individual publication, patent application, or technical standard was specifically and individually indicated to be incorporated by reference.

What is claimed is:

1. A microcapsule encapsulating a solvent, the solvent having a solubility parameter of greater than or equal to 8 (cal/cm³)^{1/2} and less than 10 (cal/cm³)^{1/2} and a molecular weight of from 425 to 3,000.

2. The microcapsule according to claim 1, wherein the solvent is an ester obtained by condensation of a polyol and a fatty acid.

3. The microcapsule according to claim 2, wherein the polyol has three or more hydroxyl groups per molecule.

4. The microcapsule according to claim 3, wherein the polyol is a polyglycerin.

5. The microcapsule according to claim 2, wherein the fatty acid is a fatty acid having 2 to 30 carbon atoms.

6. The microcapsule according to claim 1, wherein the microcapsule has a volume-standard median diameter of 1 μm to 50 μm.

7. The microcapsule according to claim 1, wherein the microcapsule has a coefficient of variation of a particle size distribution of 40% or less.

8. A method for producing microcapsule, the method comprising:
a step of dispersing an oil phase including a solvent having a solubility parameter of greater than or equal to 8 (cal/cm³)^{1/2} and less than 10 (cal/cm³)^{1/2} and a molecular weight of from 425 to 3,000 and a shell material in an aqueous phase including an emulsifier to prepare an emulsion; and
a step of polymerizing the shell material at an interface between the oil phase and the aqueous phase to form a shell, and forming a microcapsule encapsulating the solvent.

9. The method for producing microcapsule according to claim 8, wherein the solvent is an ester obtained by condensation of a polyol and a fatty acid.

10. The method for producing microcapsule according to claim 9, wherein the polyol has three or more hydroxyl groups per molecule.

11. The method for producing microcapsule according to claim 10, wherein the polyol is polyglycerin.

12. The method for producing microcapsule according to claim 9, wherein the fatty acid is a fatty acid having 2 to 30 carbon atoms.

13. The method for producing microcapsule according to claim 8, wherein the microcapsule has a volume-standard median diameter of 1 μm to 50 μm.

14. The method for producing microcapsule according to claim 8, wherein a concentration of the emulsifier is more than 0% by mass and less than or equal to 20% by mass with respect to a total mass of the emulsion.

15. The method for producing microcapsule according to claim 8, wherein the oil phase further includes an auxiliary solvent.

16. The method for producing microcapsule according to claim 8, which produces a microcapsule having a coefficient of variation of a particle size distribution of 40% or less.
